(19) United States
(12) Patent Application Publication
(10) Pub. No.: US 2007/0160955 A1
(43) Pub. Date: Jul. 12, 2007

(54) Temporary Implant Connection Structure

(75) Inventors: Dong-Hoo Han, Seoul (KR); Young-Seong Jo, Gyeongsangnam-do (KR); Kyoung-Soo Choi, Busan (KR)

Correspondence Address: LEVINE & MANDELBAUM, 444 MADISON AVENUE, 35TH FLOOR, NEW YORK, NY, 10022, US

(73) Assignee: Hong-Cheol Yoon, Seoul (KR)

(21) Appl. No.: 11/615,111

(22) Filed: Dec. 22, 2006

(30) Foreign Application Priority Data
Jan. 11, 2006 (KR) 20-2006-0000876

(51) Int. Cl. A61C 8/00

(52) U.S. Cl. 433/173; 433/174

(57) ABSTRACT

A temporary implant connection structure is used for a predetermined time in order to temporarily support a removable prosthesis for a healing period after a metal fixture is implanted into the jawbone when a tooth is damaged or missing, and thereby permanently serves as a dental root. The temporary implant connection structure includes a metal fixture, which has a threaded part, a long groove formed at the threaded part in a longitudinal direction, and a tapered head provided with a fitted part, and an abutment, which has a fitting recess press-fitted into the fitted part of the metal fixture using frictional force.

### BACKGROUND OF THE INVENTION

1. Field of the Invention

The present invention relates to a temporary implant connection structure, which is used for a predetermined time in order to temporarily support a removable prosthesis for a healing period after a ball type metal fixture or a post type metal fixture is inserted into the jawbone when a tooth is damaged or missing, and thereby permanently serves as a dental root, and particularly, which allows an abutment to be easily connected to the metal fixture using a friction-lock technique without adhesive cement, by tapering a head of the metal fixture and then an inner lower end of the abutment.

2. Description of the Prior Art

In general, an implant is an artificial tooth that is anchored in the gum or jawbone by inserting an artificial dental root, that is, a metal fixture, into the alveolus of the jawbone, osseointegrating the artificial dental root to the alveolus, connecting a support of the artificial dental root, that is, an abutment, to the artificial dental root, and covering the abutment with a prosthesis, that is, a crown. The artificial tooth can be independently implanted, and thus the implanted artificial tooth can be semi-permanently used as a natural tooth replacement that is independently supported. As such, the artificial tooth makes it possible to avoid grinding sound teeth opposite a damaged or missing tooth, to stably fix a false tooth thereto, and to improve the final appearance thereof.

In a conventional temporary implant, the artificial dental root or the metal fixture has been connected to the abutment using adhesive cement. Hence, the implanting process takes a lot of time and is inconvenient and complicated.

Further, the conventional temporary implant must use the abutment, corresponding to the head of the metal fixture, and thus has poor compatibility with the abutment.

### SUMMARY OF THE INVENTION

Accordingly, the present invention has been made keeping in mind the above problems occurring in the prior art, and an object of the present invention is to provide a temporary implant connection structure, in which a metal fixture is connected with an abutment by means of a friction-lock technique using frictional force rather than the adhesive force of adhesive cement, thereby reducing the time required to insert the metal fixture, and providing convenience to a patient as well as a secure connection between the metal fixture and the abutment, and in which a head of the metal fixture is tapered, thereby making the abutment compatible with the metal fixture regardless of the geometry of the head of the metal fixture (a ball type, a post type, etc.).

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exploded view illustrating a temporary implant connection structure according to an embodiment of the present invention;

FIG. 2 is a view for explaining the use of a temporary implant connection structure according to an embodiment of the present invention;

FIG. 3 is a view for explaining the use of compatible abutments in a temporary implant connection structure according to an embodiment of the present invention; and

FIG. 4 is an exploded view illustrating a temporary implant connection structure according to another embodiment of the present invention.

### DESCRIPTION OF THE PREFERRED EMBODIMENT INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

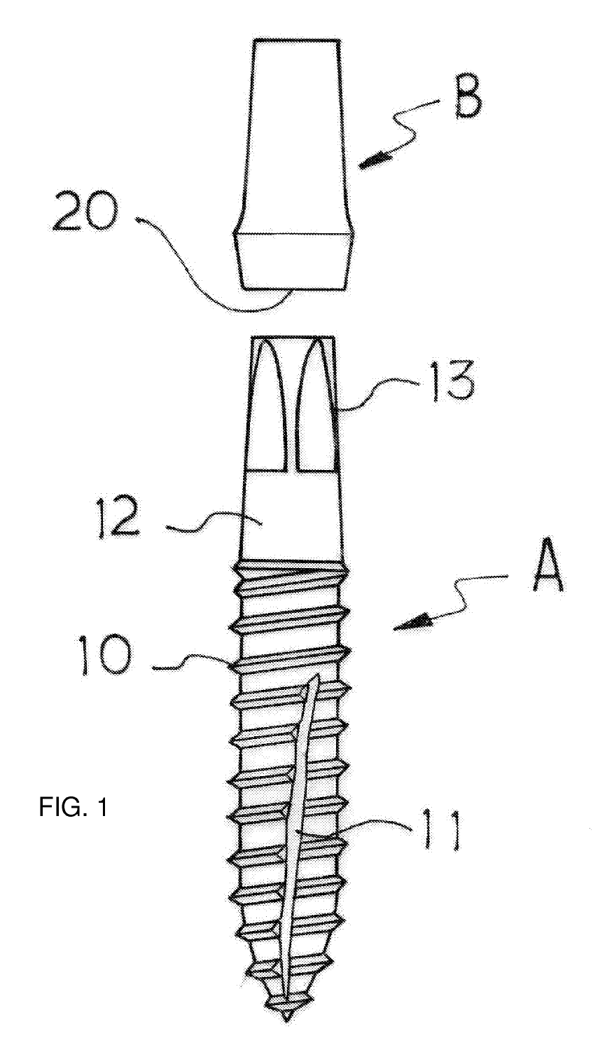

FIG. 1 is an exploded view illustrating a temporary implant connection structure according to an embodiment of the present invention, in which a post type metal fixture having a tapered head is connected with an abutment having a tapered inner lower end.

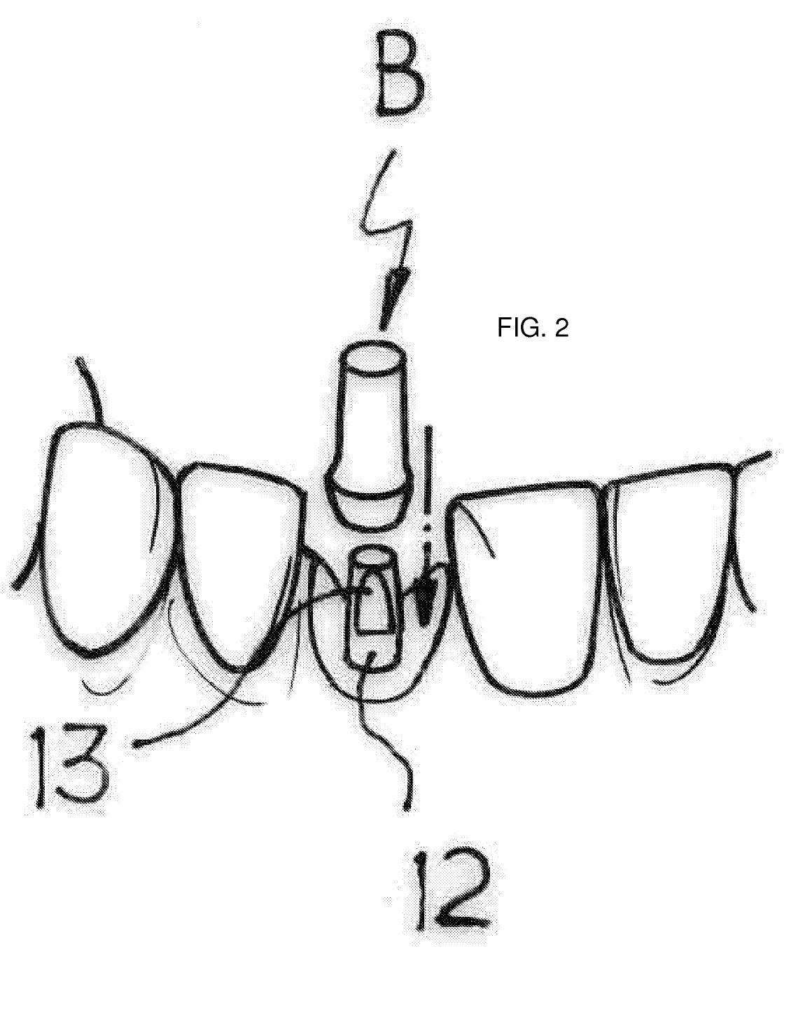

FIG. 2 is a view for explaining the use of a temporary implant connection structure according to an embodiment of the present invention, in which a metal fixture is inserted into the alveolus surrounding a damaged or extracted tooth, and then is connected with an abutment.

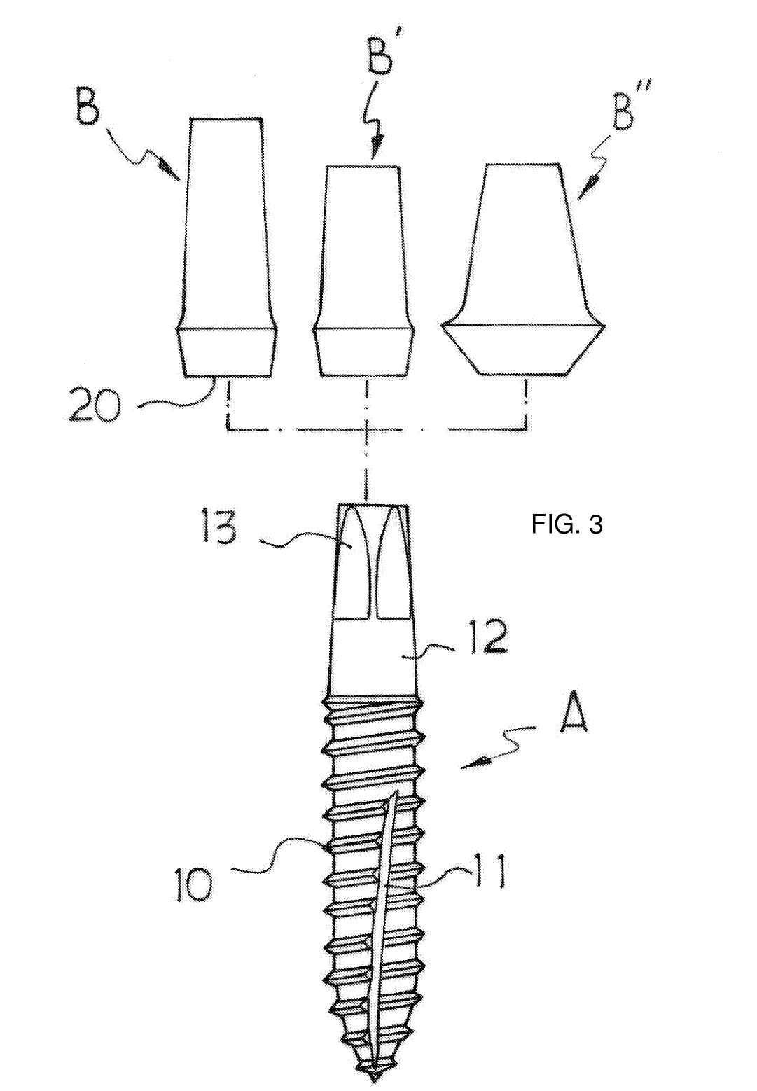

FIG. 3 is a view for explaining the use of compatible abutments in a temporary implant connection structure according to an embodiment of the present invention, in which a metal fixture is connected with any one of the compatible abutments, which are high and narrow, low and narrow, and low and wide, respectively.

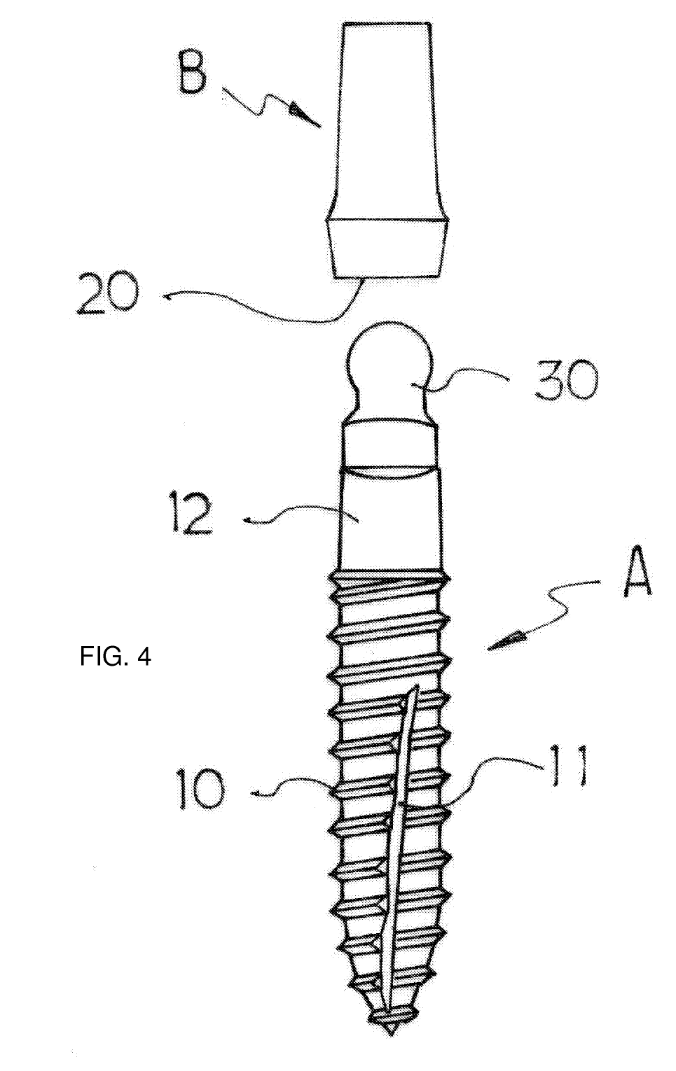

FIG. 4 is an exploded view illustrating a temporary implant connection structure according to another embodiment of the present invention, in which a ball type metal fixture having a tapered head is connected with an abutment having a tapered inner lower end.

The temporary implant connection structure, in which a metal fixture A and an abutment B are connected to form an artificial tooth, includes the metal fixture A, which has a threaded part 10, a long groove 11 formed at the threaded part 10 in a longitudinal direction, and a tapered head provided with a fitted part 12, and the abutment B, which has a fitting recess 20 press-fitted into the fitted part 12 of the metal fixture A using frictional force.

The abutment B is compatible with the metal fixture A, which is classified as a post type and a ball type according to the geometry of its head. Among the reference numerals and symbols that are not described, 13 indicates a post part, 30 indicates a ball part of the ball type metal fixture, and B′ and B″ indicate long and short abutments, which are used depending on the shape of the tooth.

The metal fixture A illustrated in FIG. 1 is the post type metal fixture A, which is provided with the threaded part 10 on an outer circumference thereof and with the post part 13 at the head thereof.

The threaded part 10 of the post type metal fixture A is provided with the long groove 11 in a longitudinal direction, so that the long groove 11 serves to facilitate the outflow of blood when the metal fixture A is inserted into the jawbone of a patient, and to cause the metal fixture A to integrate well with the alveolus of the jawbone of the patient such that the metal fixture A does not move after insertion.

The fitted part 12 of the metal fixture A is tapered like the tapered head having the post part 13.

The inner lower end of the abutment B is tapered so as to form the fitting recess 20.

As in FIG. 2, in order to connect the abutment B to the metal fixture A, the threaded part 10 of the metal fixture A is inserted into the alveolus of the jawbone without using adhesive cement. At this time, the post part 13 and the fitted part 12 constituting the tapered head of the metal fixture A protrude upwards from the gum of the patient. Then, the tapered head of the metal fixture A is connected with the fitting recess 20 of the abutment B by means of a friction-lock technique using frictional force.

This connection is based on the friction-lock technique, in which the post part 13 and the fitted part 12 constituting the head of the metal fixture A are tapered and then connected with the tapered fitting recess 20 of the abutment B.

As described above, any one of the abutments B, B′ and B″ is compatible with the temporary implant A regardless of the geometry of the head, particularly, the post or ball part 13, of the metal fixture A.

As in FIG. 3, the abutments B, B′ or B″ can be formed to have a combination of height and width corresponding to the location where a crown is to be fitted.

FIG. 4 illustrating a temporary implant connection structure according to another embodiment of the present invention, in which the ball type metal fixture A is connected with the abutment B by the same method as in the post type metal fixture A.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A temporary implant connection structure, in which a metal fixture and an abutment are connected to form an artificial tooth, comprising:
the metal fixture, which has a threaded part, a long groove formed at the threaded part in a longitudinal direction, and a tapered head provided with a fitted part; and
the abutment, which has a fitting recess press-fitted into the fitted part of the metal fixture using frictional force.
